(19) United States
(12) Patent Application Publication
(10) Pub. No.: US 2025/0181835 A1
(43) Pub. Date: Jun. 5, 2025

(54) INDIRECT LOOKUP USING SEMANTIC MATCHING AND A LARGE LANGUAGE MODEL

(71) Applicant: Intuit Inc., Mountain View, CA (US)

(72) Inventors: Lan JIN, Newark, CA (US); Shivani GOWRISHANKAR, San Jose, CA (US); Shankar SANKARARAMAN, Burlingame, CA (US)

(73) Assignee: Intuit Inc., Mountain View, CA (US)

(21) Appl. No.: 18/525,706

(22) Filed: Nov. 30, 2023

(51) Int. Cl. G06F 40/30; G06F 40/20

(52) U.S. Cl. CPC G06F 40/30; G06F 40/20

(57) ABSTRACT

A method including applying a large language model to a query to generate a query vector. The query vector has a query data structure storing a semantic meaning of the query. The method also includes applying a semantic matching algorithm to both the query vector and a lookup vector. The lookup vector has a lookup data structure storing semantic meanings of entries of a lookup table. The semantic matching algorithm compares the query vector to the lookup vector and returns, as a result of comparing, a found entry in the lookup table. The method also includes looking up, using the found entry in the lookup table, a target entry in the lookup table. The method also includes returning the target entry.

### BACKGROUND

A user of a software application may become frustrated when the user encounters difficulty supplying information requested by the software application. For example, when using tax preparation software, the software may request the user to supply a North American Industry Classification System (NAICS) code that identifies a type of the business in which the user is engaged. However, the user may not know the NAICS code, and possibly may not know what an NAICS code is or where to look for such a code. Because the user may have no knowledge about the NAICS code system, or where to start looking, the user may become frustrated.

Automatically looking up an NAICS code for the user may not be straightforward. For example, if the system requests the user to supply a description of the user's business, the user may reply with a term that does not appear in the NAICS code system. In a more specific example, the user may reply with “I am a vocal performer;” however, the term “vocal performer” may not appear in the NAICS system. Thus, the system cannot directly look up the closest NAICS category of “actor,” and accordingly cannot return the correct NAICS code.

Manual lookup tables also may fail to enable a system to return the correct NAICS code. Even if the lookup tables have additional terms for use in looking up a particular code, there are many ways to describe or phrase a desired lookup. Thus, the lookup tables may not have the terms needed to lookup the NAICS code.

In addition, term frequency-inverse document frequency (TF-IDF), another information retrieval technique, also may fail to generate satisfactory automatic results. TF-IDF relies a training data set, which may not be available. TF-IDF also may use specific wording with semantic matching algorithms, which again may result in confusion that does not result in a retrieval of the correct NAICS code.

Other machine learning techniques, such as random forests, bag-of-words approaches to training machine learning models, and others also may be impractical due to unavailability or inadequacy of training data. Thus, new techniques for indirect lookup of NAICS codes may be useful.

### SUMMARY

One or more embodiments provide for a method. The method includes applying a large language model to a query to generate a query vector. The query vector has a query data structure storing a semantic meaning of the query. The method also includes applying a semantic matching algorithm to both the query vector and a lookup vector. The lookup vector has a lookup data structure storing semantic meanings of entries of a lookup table. The semantic matching algorithm compares the query vector to the lookup vector and returns, as a result of comparing, a found entry in the lookup table. The method also includes looking up, using the found entry in the lookup table, a target entry in the lookup table. The method also includes returning the target entry.

One or more embodiments also provide for a system. The system includes a computer processor and a data repository in communication with the computer processor. The data repository stores a query. The data repository also stores a query vector having query data structure storing a semantic meaning of the query. The data repository also stores a lookup table. The data repository also stores a found entry in the lookup table and a target entry in the lookup table. The data repository also stores a lookup vector having a lookup data structure storing semantic meanings of entries of the lookup table. The system also includes a large language model which, when applied by the processor to the query, generates the query vector. The system also includes a semantic matching algorithm which, when applied by the processor to both the query vector and the lookup vector, compares the query vector to the lookup vector and returns, as a result of comparing, the found entry in the lookup table. The system also includes a lookup algorithm which, when applied by the processor to the lookup table using the found entry, looks up the target entry in the lookup table and returns the target entry.

One or more embodiments provide for another method. The method includes applying a large language model to a lookup table to generate a lookup vector. The lookup vector has a lookup data structure storing semantic meanings of entries of the lookup table. The method also includes applying, after applying the large language model to the lookup table, the large language model to a query to generate a query vector. The query vector has a query data structure storing a semantic meaning of the query. The method also includes applying a semantic matching algorithm to both the query vector and the lookup vector. The semantic matching algorithm further performs comparing the query vector to the lookup vector and returning semantic distances between the query vector and entries in the lookup table. The semantic matching algorithm further performs comparing the semantic distances to a threshold value. The semantic matching algorithm further performs adding a set of entries, from the entries, to a list of candidate entries when a corresponding semantic distance in the semantic distances satisfies the threshold value. The semantic matching algorithm further performs transmitting the list of candidate entries to a remote user device. The method also includes receiving a selection of one of the candidate entries as being a found entry in the lookup table. The method also includes looking up, using the found entry in the lookup table, a target entry in the lookup table. The method also includes returning the target entry.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2A and FIG. 2B show flowcharts of methods for indirect lookup using semantic matching and a large language model, in accordance with one or more embodiments.

FIG. 3A shows an example of a lookup table, in accordance with one or more embodiments.

FIG. 3B and FIG. 3C show data flow diagrams, in accordance with one or more embodiments.

FIG. 4 shows an example of a series of screenshots of communication between a user and a chatbot that uses a method for indirect lookup using semantic matching and a large language model to perform a desired indirect lookup, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

One or more embodiments are directed to methods for indirect lookup using semantic matching and a large language model. Thus, one or more embodiments provide a technical approach to addressing the technical challenges involved when performing a lookup of information using only an indirect reference.

When a query is received a large language model generates a query vector that includes an encoded description of a semantic meaning of the query. The query vector is compared to a lookup vector using a semantic matching algorithm. The lookup vector includes one or more encoded descriptions of semantic meanings of terms used in a lookup table that contains the information of interest. The semantic matching algorithm returns a found entry in the lookup vector that has a least semantic distance to the query vector. The “found entry” is an entry in the lookup table that was “found” by the semantic matching algorithm.

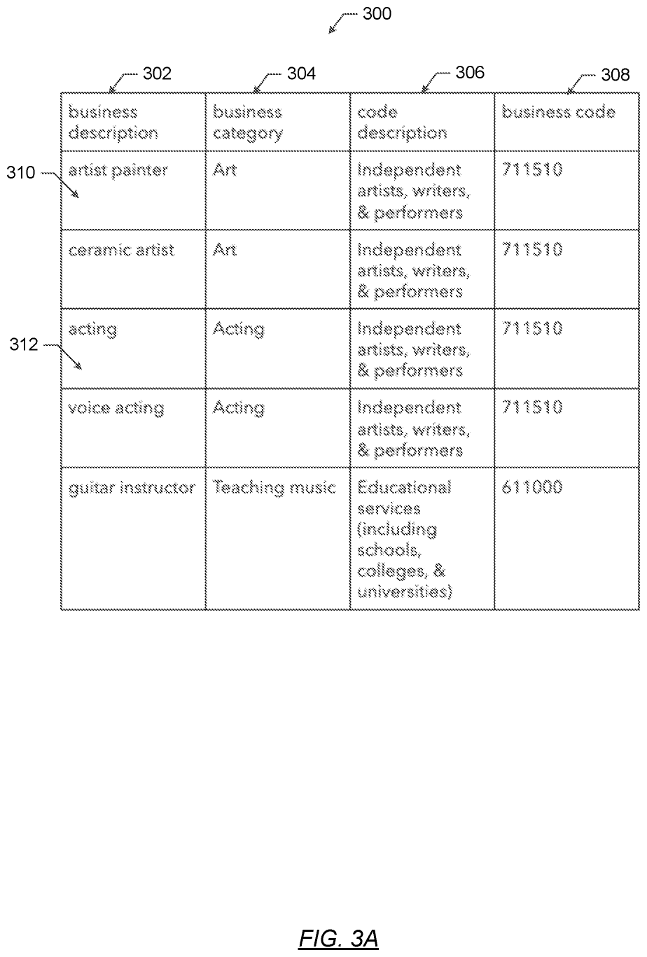

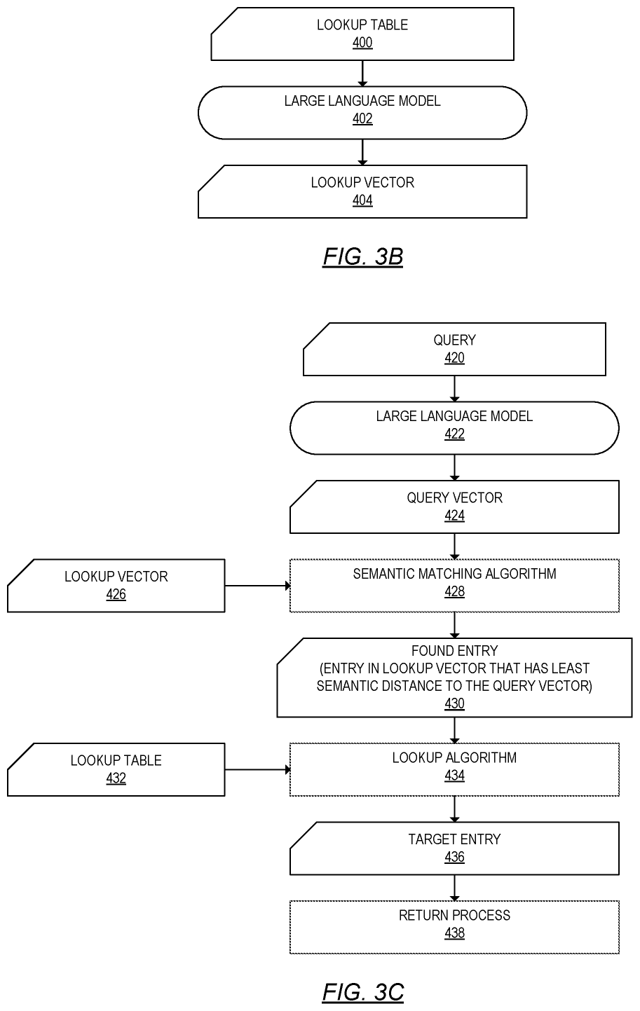

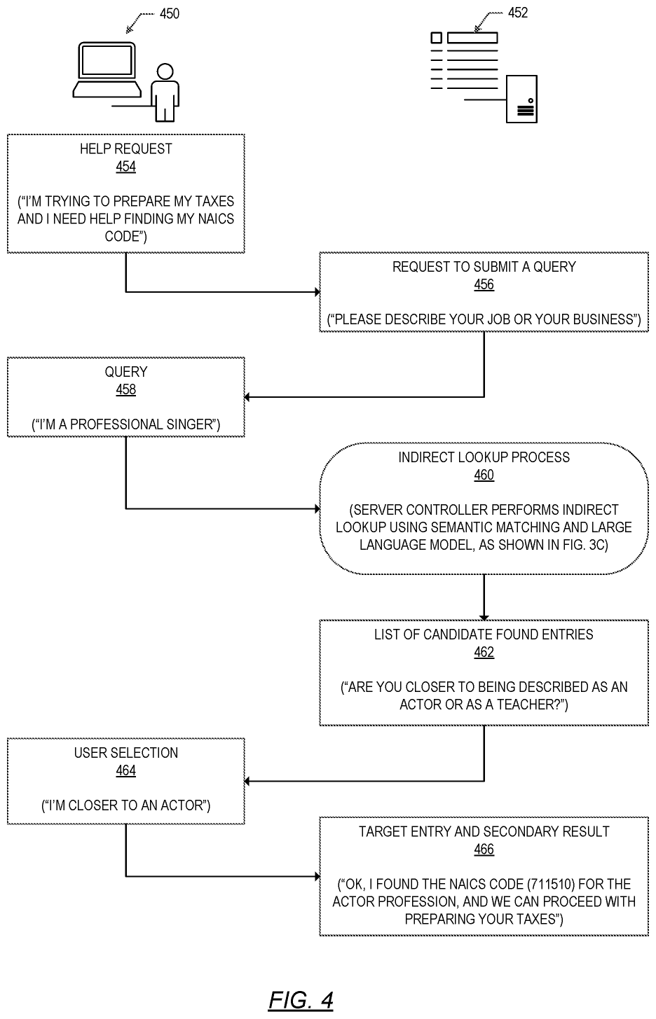

Then, a lookup algorithm compares the first entry in the lookup table to the lookup table in order to identify a corresponding target entry in the lookup table. The target entry contains the information of interest. The target entry is then returned. Thus, even if the query contains only an indirect reference to the information of interest in the target entry, one or more embodiments may find and return the target entry. Examples of this process are shown in FIG. 3A through FIG. 4.

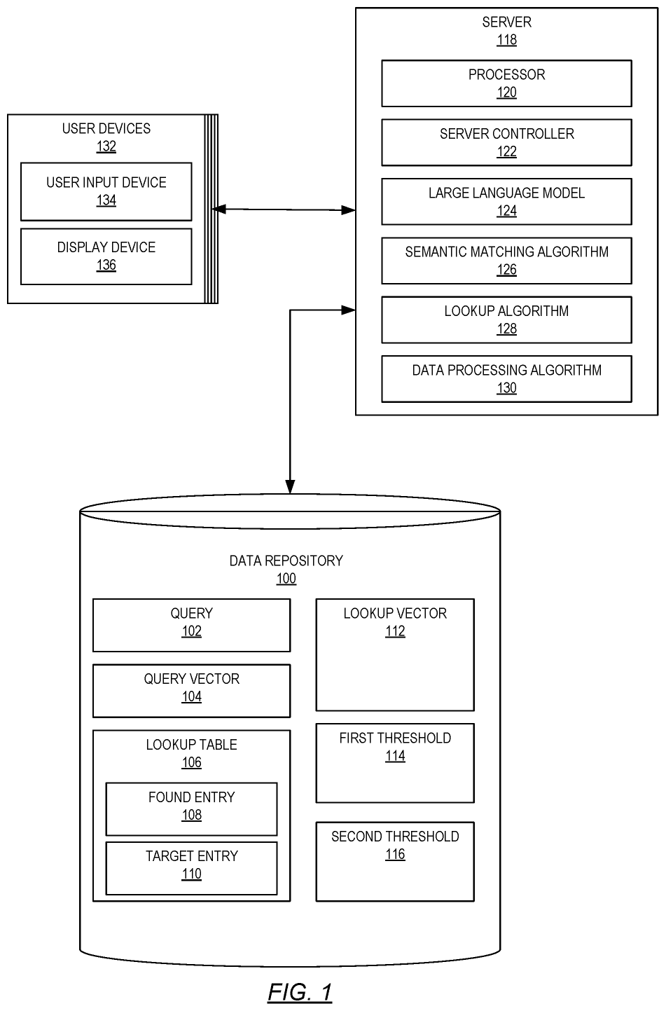

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a query (102). The query (102) is a natural language statement (i.e., a phrase or word containing alphanumeric text or special characters). The query (102), in one or more embodiments, contains an indirect reference to the information of interest (i.e., the target entry (110) defined below). An indirect reference is information that does not directly identify the target entry (110), but which has a first semantic meaning that may be compared to a second semantic meaning of one or more entries in a lookup table (106) (defined below).

The data repository (100) also stores a query vector (104). The query vector (104) is an output of the large language model (124) (defined below) when the query (102) is supplied as input to the large language model (124). The query vector (104) encodes the query (102) as a vector data structure, and also encodes a semantic meaning of the query (102) in the vector data structure.

A vector is a data structure suitable for input to, or output from, a machine learning model, and in particular is suitable for input to the large language model (124) described below. In an embodiment, a vector may be a “N” by “1” matrix, where “N” represents a number of features and where the values of the features are stored in the single row that forms the “1” dimensional matrix. However, a vector may also be a higher dimensional matrix, such as an “N” by “M” matrix, where “N” and “M” are numbers. A feature is a type of information. A value is a value for the feature.

The data repository (100) also may store a lookup table (106). The lookup table (106) is a data structure which stores information that may be queried by a lookup algorithm (128), defined below, in order to directly find information of interest. An example of a lookup table is shown in FIG. 3A.

While the term “table” is used, the lookup table (106) is not limited to a table data structure, such as a matrix or a relational database. For example, the lookup table (106) may be expressed as a graph data structure or some other data repository in other embodiments. However, the lookup table (106) contains the information of interest (e.g., the target entry (110)), and may contain one or more other entries that may aid in performing a direct lookup of the information of interest.

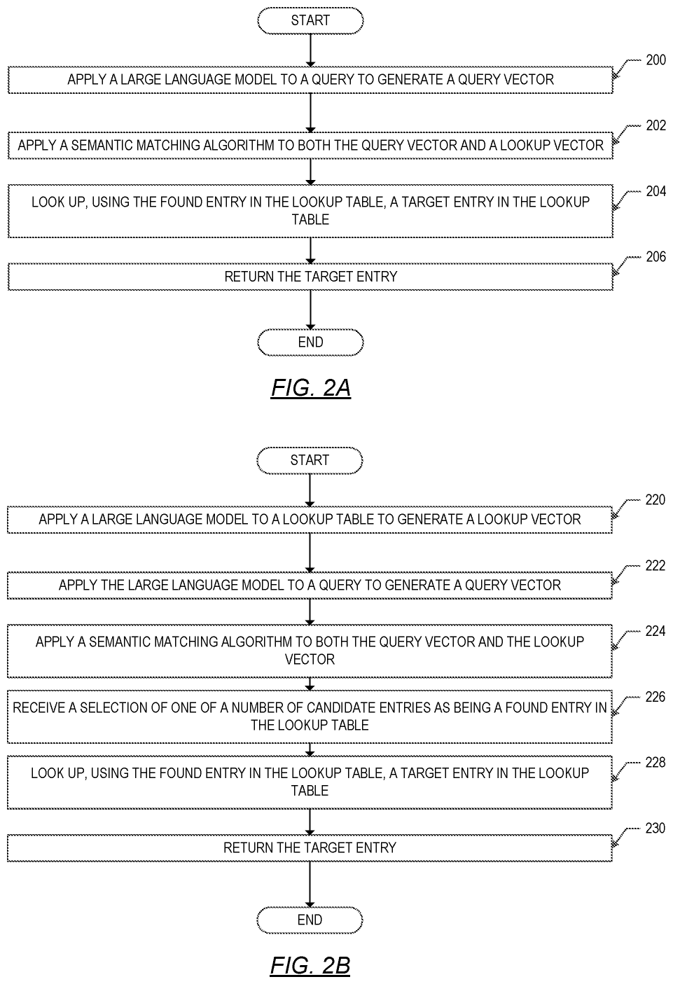

Thus, the lookup table (106) may contain a found entry (108). The found entry (108) is not the information of interest, but rather is the information that both exists in the lookup table (106) and also is found by the semantic matching algorithm (126). The found entry (108) may contain information that has a known association to the target entry (110) (defined below). Thus, once the found entry (108) in the lookup table (106) is found, a direct lookup of the target entry (110) may then be performed. Examples of this process are described in FIG. 2A, FIG. 2B, and FIG. 3C.

The lookup table (106) also may contain a target entry (110). The target entry (110) is the information of interest that exists in the lookup table (106). The target entry (110) thus is the information returned by the lookup algorithm (128), as described with respect to FIG. 2A and FIG. 2B, and as exemplified by FIG. 3C.

While the lookup table (106) has been defined as containing the found entry (108) and the target entry (110), there may be many instances of found entries that are associated with each of the target entries. For example, one target entry may be associated with many different found entries, each of which may be used to perform a direct lookup of the target entry.

In a specific example, as shown in FIG. 3A, three different found entries (the “business description,” the “business category,” and the “code description,”) are provided for a single target entry (the “business code”). If the information in any of the three found entries is discovered by the semantic matching algorithm (126), then the lookup algorithm (128) may be used to lookup the target entry (110).

The data repository (100) also stores a lookup vector (112). The lookup vector (112) is a vector, as defined above, that encodes the one or more entries (e.g., the found entry (108) and the target entry (110)) of the lookup table (106) in a vector format. The lookup vector (112) also includes encoded semantic meanings of the one or more entries in the lookup table (106).

The data repository (100) also stores a first threshold (114). The first threshold (114) is a number which may be compared to a semantic distance value between the query vector (104) and the lookup vector (112). The semantic distance value is determined by the semantic matching algorithm (126) (defined below). The number selected by the first threshold (114) may be pre-determined, or may be determined by an automated process. When the first threshold (114) is satisfied for a portion of the lookup vector (112) that represents a corresponding entry in the lookup table (106), then the corresponding entry in the lookup table (106) is returned as the found entry (108). The target entry (110) may then be looked up from the found entry (108), as described with respect to FIG. 2A or FIG. 2B.

The first threshold (114) may be satisfied when a pre-determined condition exists relative to the semantic distance value. For example, the pre-determined condition may be the semantic distance value being above the first threshold (114), below the first threshold (114), equal to or above the first threshold (114), equal to or below the first threshold (114), or equal to the first threshold (114). The exact pre-determined condition that results in satisfaction of the first threshold (114) depends on the particular implementation of one or more embodiments, but in one embodiment the semantic distance value may satisfy the first threshold (114) when the semantic distance value equals or exceeds the first threshold (114).

The second threshold (116) is also a number which may be compared to the semantic distance value between the query vector (104) and the lookup vector (112). While the second threshold (116) may be determined in a similar manner as the first threshold (114), and satisfied in a similar manner, the second threshold (116) is different from the first threshold (114). However, when the second threshold (116) is satisfied for a portion of the lookup vector (112) that represents a corresponding entry in the lookup table (106), then the corresponding entry in the lookup table (106) is returned as a candidate found entry. The candidate found entry may be added to a list of candidate entries for presentation to a user, as described with respect to FIG. 2B.

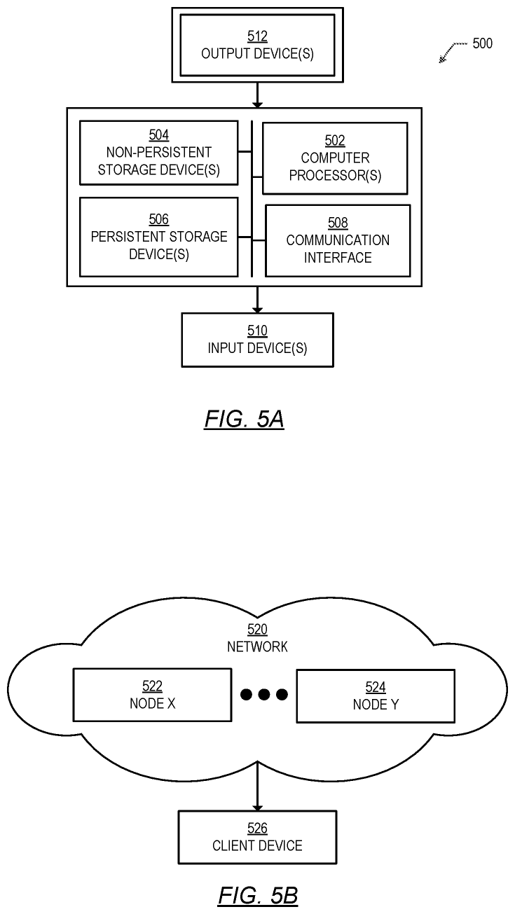

The system shown in FIG. 1 may include other components. For example, the system shown in FIG. 1 also may include a server (118). The server (118) is one or more computing systems, possibly operating in a distributed computing environment. An example of the server (118) may be the computing system (500) shown in FIG. 5A.

The server (118) includes a processor (120). The processor (120) is one or more hardware or virtual processors which may execute one or more controllers, software applications, algorithms, or models as described herein. The processor (120) may be the computer processor(s) (502) in FIG. 5A.

The server (118) may host a server controller (122). The server controller (122) is software or application specific hardware that, when executed by the processor, performs one or more operations described with respect to the method of FIG. 2A, the method of FIG. 2B, or the data flow shown in FIG. 3B or FIG. 3C. The server controller (122) also may coordinate operations of the large language model (124), the semantic matching algorithm (126), the lookup algorithm (128), and the data processing algorithm (130). For example, the server controller (122) may control the data flow shown in FIG. 3B or FIG. 3C, and may implement the example shown in FIG. 4.

The server (118) also may store a large language model (124). The large language model (124) is a type of machine learning model that processes text. The large language model takes text as input and transforms the input into an output. For example, the large language model may summarize (the output) a large corpus of text (the input). The large language model also may encode text into a computer data structure (e.g., a vector) and also may encode the semantic meaning of that text. An example of the large language model (124) may be CHATGPT®.

The large language model (124) may be a transformer-based large language model that is pre-trained on sentence data sets. In this manner, the large language model (124) may be trained to recognize the semantic meanings of phrases in a query based on a context understood from the order or presentation of words within a phrase or sentence. Additionally, the large language model (124) may be programmed to map phrases to a multi-dimensional dense vector space suitable for a computer to perform vector similarity comparisons. In other words, the large language model (124) may be programmed to generate the query vector (104) or the lookup vector (112), and not simply generate text as output.

The server (118) also may include a semantic matching algorithm (126). The semantic matching algorithm (126) is software or application specific hardware which, when applied by the processor (120) to the query vector (104) and the lookup vector (112), may determine a semantic distance between the query vector (104) and portions of the lookup vector (112) that represent corresponding entries in the lookup table (106). Examples of the semantic matching algorithm (126) may be a Jaccard similarity machine learning model, a cosine similarity machine learning model, a K-means clustering machine learning model, a latent semantic indexing machine learning model, a latent Dirichlet allocation machine learning model. Other machine learning models and algorithms also could be used, including possibly a non-machine learning algorithm.

Computationally, semantic similarity may be estimated by defining a topological similarity by using ontologies to define the distance between terms and concepts. For example, a metric for the comparison of concepts ordered in a partially ordered set and represented as nodes of a directed acyclic graph (e.g., a taxonomy) may be the shortest path linking the two concept nodes. Based on text analyses, semantic relatedness between units of language (e.g., words, sentences) can also be estimated using statistical means such as a vector space model to correlate words and textual contexts from a suitable text corpus.

The evaluation of the proposed semantic similarity or relatedness measures are evaluated using at least two techniques. In one technique, datasets composed of word pairs with semantic similarity may be based on a pre-determined relatedness degree estimation. In another technique, the integration of the measures inside specific applications such as information retrieval, recommender systems, natural language processing, etc. may be used to determine semantic similarity.

The server (118) also stores a lookup algorithm (128). The lookup algorithm (128) is software or application specific hardware programmed to perform a lookup function. An example of the lookup algorithm (128) may be a relational database program with a search function. The lookup algorithm (128) is programmed to find the target entry (110) once the found entry (108) has been identified.

The server (118) also may store a data processing algorithm (130). The data processing algorithm (130) is software or application specific hardware which may be used to perform some other processing function using the target entry (110) as input. For example, assume that the method of FIG. 2A or FIG. 2B were used to find a target entry in the form of an NAICS code (see FIG. 4). The data processing algorithm (130) in this case may be tax preparation software which takes the NAICS code as input.

The user devices (132) may include one or more user input devices, such as the user input device (134). The user input devices are keyboards, mice, microphones, cameras, etc. with which a user may provide input to the user devices (132).

The user devices (132) may include one or more display devices, such as the display device (136). The display devices are monitors, televisions, touchscreens, etc. which may display information to a user.

While FIG. 1 shows a configuration of components, other configurations may be used without departing from the scope of one or more embodiments. For example, various components may be combined to create a single component. As another example, the functionality performed by a single component may be performed by two or more components.

FIG. 2A and FIG. 2B show flowcharts of methods for methods for indirect lookup using semantic matching and a large language model, in accordance with one or more embodiments. The method of FIG. 2A and FIG. 2B may be implemented using the system shown in FIG. 1, possibly in conjunction with the computing system shown in FIG. 5A and FIG. 5B.

Turning to FIG. 2A, step 200 includes applying a large language model to a query to generate a query vector. The query vector includes a query data structure storing a semantic meaning of the query. The large language model may be applied by generating a prompt for the large language model as input. The prompt may include a command, a system message, and one or more elements of input data. The input data may include, for example, a query, a lookup table, or some other form of text. The output of the large language model is transformed text, but also may be an encoding of the text in a vector format. Thus, the large language model may be used to accept the query as input and to generate the query vector as output.

Step 202 includes applying a semantic matching algorithm to both the query vector and a lookup vector. The lookup vector includes a lookup data structure storing semantic meanings of entries of a lookup table. The semantic matching algorithm compares the query vector to the lookup vector and returns, as a result of comparing, a found entry in the lookup table. The semantic matching algorithm may be applied by using the query vector and the lookup vector as inputs to be compared against each other. The semantic matching algorithm may generate, as output, one or more semantic distances between the query vector and the lookup vector as output.

It is possible to generate multiple semantic distances between the query vector and the lookup vector, because the lookup vector may encode multiple different entries for a lookup table. An entire table may be encoded so that the semantic matching algorithm may compare the query vector to each entry within the lookup vector. The result may be multiple semantic distances.

A least value of the semantic distance may be used to identify the corresponding entry in the lookup table that has the closest semantic meaning to the query, relative to other entries in the lookup table. In other words, comparing the query vector to the lookup vector may include identifying the found entry in the lookup vector as having a least semantic distance to the query vector, relative to other entries in the lookup table.

Alternatively, a semantic distance above a first threshold may be compared to the semantic values, and the corresponding entry that has a semantic value that satisfies the threshold may be returned as the found entry in the lookup table. Alternatively, a list of semantic distances above a second threshold may be identified, and the corresponding entries in the lookup table returned. The list of entries may be transmitted (e.g. to a user or some other process) and then a selected one of the entries received. The selected one of the entries then becomes the found entry in the lookup table.

Thus, in an integrated example, comparing the query vector to the lookup vector may include identifying the found entry in the lookup vector as having a semantic distance to the query vector. The semantic distance is compared to a first threshold value. Responsive to the semantic distance failing to satisfy the first threshold value, the semantic distance is compared to a second threshold value. Responsive to the semantic distance satisfying the second threshold value, the found entry is added to a list of candidate entries including additional entries in the lookup vector. The list of candidate entries is transmitted to a user device. A selection of the found entry from the list of candidate entries is received from the user device.

Step 204 includes looking up, using the found entry in the lookup table, a target entry in the lookup table. The process of looking up may be performed by finding a target value that exists in the same set of entries as the found entry. For example, assume the lookup table is a relational database composed of rows and columns, where the rows are different entities and the columns represent the various entries for each of the entities. The found entry may be used to identify the row where the target entry exists. The target entry for the row is returned as the target entry. See, for example, FIG. 3C in reference to FIG. 3A for performing a lookup of a target entry based on a found entry in a lookup table.

Step 206 includes returning the target entry. The target entry may be returned by one of a number of techniques. For example, returning the target entry may include storing the target entry in a data repository. Returning the target entry may include presenting the target entry on a graphical user interface (GUI). Returning the target entry may include providing the target entry to some other data processing algorithm. See, for example, FIG. 4 where a target entry of an NAICS code is provided to a tax preparation software.

The method of FIG. 2A may be varied. For example, the method also may include generating the lookup vector. In particular, the method may include applying, prior to applying the semantic matching algorithm, the large language model to the lookup table to generate the lookup vector.

In addition, the method may be updated any time a new entry or a revised entry for the lookup table is generated, or even when an entirely new lookup table is provided. In this case, the method includes receiving, prior to applying the semantic matching algorithm, a new entry to a new lookup table, a revised lookup table, or an entirely different lookup table. Then, the method may include applying, prior to applying the semantic matching algorithm, the large language model to the new lookup table with the new entry, to the revised lookup table, or to the different lookup table to generate the lookup vector,

Still other variations are possible. Thus, one or more embodiments are not necessarily limited to the method shown in FIG. 2A.

For example, attention is now turned to FIG. 2B, which may be an extension of the method of FIG. 2A.

Step 220 includes applying a large language model to a lookup table to generate a lookup vector. The lookup vector includes a lookup data structure storing semantic meanings of entries of the lookup table. The generation of the lookup vector is similar to the process of generating a query vector at step 200 of FIG. 2A, but instead of applying the large language model to the query, the large language model is applied to the lookup table.

Step 222 includes applying, after applying the large language model to the lookup table, the large language model to a query to generate a query vector. The query vector includes a query data structure storing a semantic meaning of the query. Step 222 is similar to step 200 of FIG. 2A.

Step 224 includes applying a semantic matching algorithm to both the query vector and the lookup vector. While step 224 may be similar to step 202 of FIG. 2A, step 224 may include additional sub-steps.

In particular, the semantic matching algorithm further performs a sub-step of comparing the query vector to the lookup vector and returning semantic distances between the query vector and entries in the lookup table. As indicated above, a semantic comparison is made between the query vector and each portion of the lookup vector that represents an entry in the lookup table. Thus, multiple semantic values are generated.

The semantic matching algorithm may further perform a sub-step of comparing the semantic distances to a threshold value. Comparing is as described with respect to step 202, and the threshold value may be the second threshold (116) as described with respect to FIG. 1.

The semantic matching algorithm further may perform a sub-step of adding a set of entries, from the entries, to a list of candidate entries when a corresponding semantic distance in the semantic distances satisfies the threshold value. The list is thus composed of entries in the lookup table and respective semantic values for the entries. The list may be organized in ascending order of semantic distance. Hence, the entry having the least semantic distance may be presented first and entries then presented in increasing semantic distances may be presented thereafter.

The semantic matching algorithm may further perform a sub-step of transmitting the list of candidate entries to a remote user device. Transmitting may be performed via electronic message, private message, email, chatbot, or any other form of electronic communication.

Step 226 includes receiving a selection of one of the candidate entries as being a found entry in the lookup table. The selection may be received via the electronic message, private message, email, chatbot, or any other form of electronic communication. The selection is received from the user device. The selection reflects the decision of the user operating the user device, or perhaps represents the decision of some other automated process performed at the remote user device.

Step 228 includes looking up, using the found entry in the lookup table, a target entry in the lookup table. Step 228 is similar to step 204 of FIG. 2A.

Step 230 includes returning the target entry. Step 230 is similar to step 206 of FIG. 2A.

While the various steps in the flowcharts of FIG. 2A and FIG. 2B are presented and described sequentially, at least some of the steps may be executed in different orders, may be combined or omitted, and at least some of the steps may be executed in parallel. Furthermore, the steps may be performed actively or passively.

FIG. 3A, FIG. 3B, FIG. 3C, and FIG. 4 show examples of methods for indirect lookup using semantic matching and a large language model, in accordance with one or more embodiments. The following example is for explanatory purposes only and not intended to limit the scope of one or more embodiments. The example shown is in the context of indirect lookup of NAICS codes for purposes of providing the NAICS codes to tax preparation software when a user of the tax preparation software does not know the user's NAICS code.

FIG. 3A shows a lookup table (300), which may be the lookup table (106) of FIG. 1. The lookup table (300) includes a number of entries that may serve as “found entries,” such as the found entry (108) of FIG. 1. The types of the entries are arranged as columns, such as a business description column (302), the business category column (304), and a code description column (306). The lookup table (300) also includes a set of entries that may serve as the “target entry,” such as the target entry (110) of FIG. 1. In particular, the business code column (308) contains different NAICS codes that correspond to the other entries in the lookup table (300).

The rows of the lookup table (300) are different specific entries for the entry types of the columns for any given business code. Thus, the artist painter row (310) provides the business description, business category, and code description entries that correspond to the NAICS business code for the artist painter row (310). Similarly, the acting row (312) provides the business description, business category, and code description that corresponds to the NAICS business code for the acting row (312).

FIG. 3B shows a data flow for generating the lookup vector described with respect to FIG. 1, FIG. 2A, and FIG. 2B. The lookup table (400), which in this example is the lookup table (300) shown in FIG. 3 is stored in a data repository. A large language model (402) may be applied to the lookup table (400). In another embodiment, the large language model (402) also may be applied to the lookup table (400) by combining the lookup table (400), a command, and a system message into a prompt. In this latter case, the prompt serves as input to the large language model (402), which is then executed by a processor. In either case (whether the large language model (402) is applied to the lookup table (400) directly or indirectly through a prompt) the output of the large language model (402) is a lookup vector (400), which may be as described with respect to the lookup vector (112) of FIG. 1 and generated as described with respect to FIG. 2A.

FIG. 3C shows a data flow which may be used after the lookup vector (404) is generated in FIG. 3B. Initially, a query (420) is received. A large language model (422) is applied to the query (420) to generate a query vector (424), in a manner similar to step 200 in FIG. 2A.

Then, a semantic matching algorithm (428) is applied to the query vector (424) and a lookup vector (426), as described with respect to step 202 of FIG. 2A. The output of the semantic matching algorithm (428) is a found entry (430). The found entry (430) is the entry in the lookup vector (426) that has a least semantic distance to the query vector (424).

Next, a lookup algorithm (434) is applied to the found entry (430) and a lookup table (432), as described with respect to step 204 of FIG. 2A. The lookup table (432) is the lookup table (300) shown in FIG. 3. The output of the lookup algorithm (434) is the target entry (436). The target entry is then returned at the return process (438), as described with respect to step 206 of FIG. 2A.

Attention is next turned to FIG. 4, which shows an example of a series of screenshots of communication between a user and a chatbot that uses a method for indirect lookup using semantic matching and a large language model to perform a desired indirect lookup, in accordance with one or more embodiments. The example references a user device (450) in communication with a server (452). The server (452) executes a chatbot for communicating with the user device (450). The server (452) also may execute the methods of FIG. 2A and FIG. 2B, as well as the data flows of FIG. 3B and FIG. 3C.

The user device (450) submits a help request (454). The user submits a request in a dialog box for providing input to the chatbot. The request states, in natural language text, “I'm trying to prepare my taxes and I need help finding my NAICS code.” Note that the request is not the query, as described with respect to FIG. 1 through FIG. 3C, but rather is a general request for help.

The text is transmitted to the server (452). In response, the server (452) has been programmed to request the user to submit a query that will assist the server (452) to find the particular user's NAICS code. In particular, the request to submit a query (456) is “Please describe your job or your business.”

The user, in response, supplies a query (458). The query states, “I'm a professional singer.” The term “singer” or “professional singer” does not appear in the lookup table (300) of FIG. 3A. Thus, the server (452) is not able to perform a direct lookup of the NAICS code for the user.

Accordingly, the server (452) initiates an indirect lookup process (460). The indirect lookup process (460) is the data flow shown in FIG. 3C. The query vector, in this case, is the vector form of the query (458) and the encoded semantic meaning of the query (458). The lookup vector is the lookup vector previously generated using the data flow shown in FIG. 3B. The method may proceed as described with respect to FIG. 2A or FIG. 2B.

In this example, none of the candidate found entries had semantic distances above a first threshold value which would indicate a strong semantic match. Thus, a list of candidate found entries are returned, with each of the candidate found entries having a semantic distance within a second threshold of the semantic meaning of the query vector. The candidate entries are “actor” and “teacher.” However, the server (452) uses the large language model to generate a more natural language statement which may be more understandable to the user. Thus, the server (452) returns the following statement to the user device (450) via the chatbot: “Are you closer to being described as an actor or as a teacher?”

The user makes a selection and then returns a user selection (464) to the chatbot. In this case, the user indicates that the user is closer to being an actor, rather than being closer to being a teacher. The term “actor” semantically very close to one of the terms used in one of the found entries in the lookup table (300) of FIG. 3A. Specifically, the term “acting” is a derivation of the word “actor,” and thus the server identifies “acting” or “voice acting” as being the found entry in the lookup table (300), and specifically is the acting row (312) in the business description column (302) of the lookup table (300).

The server (452) now performs a lookup process to find the value in the business code column (308) that corresponds to the acting row (312) in the business description column (302) of the lookup table (300) of FIG. 3A. The NAICS code pertaining to the user is 711510.

The chatbot then provides an answer satisfactory to the user, namely the target entry and secondary result (466). In particular, the server (452) returns the following statement to the user device (450) via the chatbot: “OK, I found the NAICS code (711510) for the actor profession, and we can proceed with preparing your taxes.” The NAICS code is provided to the tax preparation software (corresponding to the data processing algorithm (130) of FIG. 1), and the user is able to complete the user's tax preparation process. The target entry is the NAICS code, and the secondary result is the transmission of the NAICS code to the tax preparation software.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores or micro-cores of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output devices may be the same or different from the input device(s) (510). The input and output device(s) may be locally or remotely connected to the computer processor(s) (502). Many different types of computing systems exist, and the aforementioned input and output device(s) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
applying a large language model to a query to generate a query vector, wherein the query vector comprises a query data structure storing a semantic meaning of the query;
applying a semantic matching algorithm to both the query vector and a lookup vector, wherein:
the lookup vector comprises a lookup data structure storing a plurality of semantic meanings of a plurality of entries of a lookup table, and
the semantic matching algorithm compares the query vector to the lookup vector and returns, as a result of comparing, a found entry in the lookup table;
looking up, using the found entry in the lookup table, a target entry in the lookup table; and
returning the target entry.

2. The method of claim 1, wherein comparing the query vector to the lookup vector comprises identifying the found entry in the lookup vector as having a least semantic distance to the query vector, relative to other entries in the lookup table.

3. The method of claim 1, wherein comparing the query vector to the lookup vector comprises:
identifying the found entry in the lookup vector as having a semantic distance to the query vector;
comparing the semantic distance to a threshold value; and
returning the found entry when the semantic distance satisfies the threshold value.

4. The method of claim 1, wherein comparing the query vector to the lookup vector comprises:
identifying the found entry in the lookup vector as having a semantic distance to the query vector;
comparing the semantic distance to a first threshold value;
comparing, responsive to the semantic distance failing to satisfy the first threshold value, the semantic distance to a second threshold value;
adding, responsive to the semantic distance satisfying the second threshold value, the found entry to a list of candidate entries comprising additional entries in the lookup vector;
transmitting, to a user device, the list of candidate entries; and
receiving, from the user device, a selection of the found entry from the list of candidate entries.

5. The method of claim 1, wherein looking up the target entry comprises:
looking up, using the found entry, a plurality of second entries in the lookup table, wherein the target entry is among the plurality of second entries;
transmitting, to a user device, the plurality of second entries; and
receiving, from the user device, a selection of the target entry in the lookup table.

6. The method of claim 1, further comprising:
applying, prior to applying the semantic matching algorithm, the large language model to the lookup table to generate the lookup vector.

7. The method of claim 1, further comprising:
receiving, prior to applying the semantic matching algorithm, a new entry to a new lookup table; and
applying, prior to applying the semantic matching algorithm, the large language model to the new lookup table to generate the lookup vector,
wherein the new lookup table is the lookup table when looking up the target entry.

8. The method of claim 1, wherein the large language model comprises a transformer-based large language model that is pre-trained on sentence data sets.

9. The method of claim 1, wherein the large language model is programmed to map phrases to a multi-dimensional dense vector space suitable for a computer to perform vector similarity comparisons.

10. The method of claim 1, wherein returning comprises providing the target entry to a data processing algorithm programmed to process the target entry to generate a secondary result.

11. A system comprising:
a computer processor;
a data repository in communication with the computer processor and storing:
a query,
a query vector comprising query data structure storing a semantic meaning of the query,
a lookup table,
a found entry in the lookup table and a target entry in the lookup table, and
a lookup vector comprising a lookup data structure storing a plurality of semantic meanings of a plurality of entries of the lookup table,
a large language model which, when applied by the processor to the query, generates the query vector;
a semantic matching algorithm which, when applied by the processor to both the query vector and the lookup vector, compares the query vector to the lookup vector and returns, as a result of comparing, the found entry in the lookup table; and
a lookup algorithm which, when applied by the processor to the lookup table using the found entry, looks up the target entry in the lookup table and returns the target entry.

12. The system of claim 11, wherein the semantic matching algorithm comparing the query vector to the lookup vector comprises identifying the found entry in the lookup vector as having a least semantic distance to the query vector, relative to other entries in the lookup table.

13. The system of claim 11, wherein the semantic matching algorithm comparing the query vector to the lookup vector comprises the semantic matching algorithm:
identifying the found entry in the lookup vector as having a semantic distance to the query vector;
comparing the semantic distance to a threshold value; and
returning the found entry when the semantic distance satisfies the threshold value.

14. The system of claim 11, wherein the semantic matching algorithm comparing the query vector to the lookup vector comprises the semantic matching algorithm:
identifying the found entry in the lookup vector as having a semantic distance to the query vector;
comparing the semantic distance to a first threshold value;
comparing, responsive to the semantic distance failing to satisfy the first threshold value, the semantic distance to a second threshold value;
adding, responsive to the semantic distance satisfying the second threshold value, the found entry to a list of candidate entries comprising additional entries in the lookup vector;
transmitting, to a user device, the list of candidate entries; and
receiving, from the user device, a selection of the found entry from the list of candidate entries.

15. The system of claim 11, wherein the lookup algorithm looking up the target entry comprises:
looking up, using the found entry, a plurality of second entries in the lookup table, wherein the target entry is among the plurality of second entries;
transmitting, to a user device, the plurality of second entries; and
receiving, from the user device, a selection of the target entry in the lookup table.

16. The system of claim 11, wherein the large language model, when applied by the processor to the lookup table prior to applying the semantic matching algorithm, generates the lookup vector.

17. The system of claim 11, wherein:
the data repository further stores a new lookup table,
the large language model, when applied by the processor to the new lookup table prior to applying the semantic matching algorithm, generates the lookup vector, and
the new lookup table is the lookup table when the lookup algorithm returns the target entry.

18. The system of claim 11, wherein the large language model is programmed to map phrases to a multi-dimensional dense vector space suitable for a computer to perform vector similarity comparisons.

19. The system of claim 11, wherein the system further comprises:
a data processing algorithm which, when applied by the processor to the target entry, processes the target entry to generate a secondary result.

20. A method comprising:
applying a large language model to a lookup table to generate a lookup vector, wherein the lookup vector comprises a lookup data structure storing a plurality of semantic meanings of a plurality of entries of the lookup table;
applying, after applying the large language model to the lookup table, the large language model to a query to generate a query vector, wherein the query vector comprises a query data structure storing a semantic meaning of the query;
applying a semantic matching algorithm to both the query vector and the lookup vector, and wherein the semantic matching algorithm further performs:
comparing the query vector to the lookup vector and returning a plurality of semantic distances between the query vector and a plurality of entries in the lookup table,
comparing the plurality of semantic distances to a threshold value,
adding a set of entries, from the plurality of entries, to a list of candidate entries when a corresponding semantic distance in the plurality of semantic distances satisfies the threshold value, and
transmitting the list of candidate entries to a remote user device;
receiving a selection of one of the candidate entries as being a found entry in the lookup table;
looking up, using the found entry in the lookup table, a target entry in the lookup table; and
returning the target entry.
